(19) United States
(12) Patent Application Publication
(10) Pub. No.: US 2025/0279518 A1
(43) Pub. Date: Sep. 4, 2025

(54) ENERGY STORAGE SYSTEM WITH PRE-CERAMIC POLYMER COATED ELECTRICALLY CONDUCTIVE COMPONENTS FOR ELECTRICAL ISOLATION

(71) Applicant: GLOBAL TECHNOLOGY OPERATIONS LLC, Detroit, MI (US)

(72) Inventors: Mohammad Hamza Kirmani, Troy, MI (US); Joseph Nicholas LOVRIA, Davisburg, MI (US); Andrew MCINERNEY, Washington, MI (US); Anthony Michael COPPOLA, Rochester Hills, MI (US); Harinder Pal Singh SANDHU, Northville, MI (US)

(21) Appl. No.: 18/591,847

(22) Filed: Feb. 29, 2024

(51) Int. Cl. H01M 50/229; H01M 10/653; H01M 50/207

(52) U.S. Cl. CPC H01M 50/229; H01M 10/653; H01M 50/207; H01M 2220/20

(57) ABSTRACT

An energy storage system is disclosed and includes: at least one battery pack; and one or more electrically conductive components each of which including one or more pre-ceramic polymer layers, where the one or more pre-ceramic polymer layers of each of the one or more electrically conductive components electrically insulate the one or more electrically conductive components from other electrically conductive components of the at least one battery pack.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to electrical isolation of electrically conductive components in energy storage systems.

Advanced energy storage devices and systems are in demand to satisfy energy and/or power requirements for a variety of products, including automotive and non-automotive products such as start-stop systems (e.g., 12V start-stop systems), battery-assisted systems, hybrid electric vehicles (“HEVs”), electric vehicles (“EVs”), network devices, portable electronic devices, electric bikes, power storage devices, etc. These products include batteries, such as lithium-ion batteries and/or other batteries.

### SUMMARY

An energy storage system is disclosed and includes: at least one battery pack; and one or more electrically conductive components each of which including one or more pre-ceramic polymer layers, where the one or more pre-ceramic polymer layers of each of the one or more electrically conductive components electrically insulate the one or more electrically conductive components from other electrically conductive components of the at least one battery pack.

In other features, the at least one battery pack includes the one or more electrically conductive components.

In other features, the one or more pre-ceramic polymer layers of the one or more electrically conductive components maintain electrical insulation of the one or more electrically conductive components up to at least melting points of the one or more electrically conductive components.

In other features, the one or more pre-ceramic polymer layers of the one or more electrically conductive components includes at least one of polysilazane (organics polysilazane (OPSZ)), polycarboslilane, polymeric aluminum phosphate, ceramics including boron nitride, nanotubes, titanium nitride, chromium carbide, magnesium zirconate, zirconia, titanium, and tungsten.

In other features, the one or more pre-ceramic polymer layers of the one or more electrically conductive components includes a silicone resin.

In other features, the one or more electrically conductive components include at least one of a battery cell, a flex circuit, a busbar, a connector, a current collector, a structural enclosure, a heat exchanger, and a cooling plate.

In other features, the one or more electrically conductive components include battery cells that are cylindrically shaped, prismatically shaped, or pouch shaped.

In other features, the battery cells are stacked.

In other features, the one or more electrically conductive components include connectors connecting battery cells.

In other features, the one or more electrically conductive components include a current connector connected to battery cells.

In other features, the one or more pre-ceramic polymer layers of the one or more electrically conductive components are thicker at edges of the one or more electrically conductive components than at other areas of the one or more electrically conductive components.

In other features, the one or more pre-ceramic polymer layers of the one or more electrically conductive components have UL-94 ratings of V0 or V1.

In other features, the one or more electrically conductive components are potted such that at least portions of the one or more electrically conductive components including corresponding portions of the one or more pre-ceramic polymer layers are disposed in potting material.

In other features, the one or more electrically conductive components includes pre-ceramic polymer layers including the one or more pre-ceramic polymer layers.

In other features, a method of manufacturing an energy storage system is disclosed. The method includes: selecting one or more electrically conductive components to coat; pretreating surfaces of the one or more electrically conductive components; coating the one or more electrically conductive components with a pre- ceramic polymer material to form one or more pre-ceramic polymer layers on surfaces of the one or more electrically conductive components; and curing the one or more pre-ceramic polymer coating layers.

In other features, the one or more pre-ceramic polymer layers of the one or more electrically conductive components includes at least one of polysilazane (organics polysilazane (OPSZ)), polycarboslilane, polymeric aluminum phosphate, ceramics including boron nitride, nanotubes, titanium nitride, chromium carbide, magnesium zirconate, zirconia, titanium, and tungsten.

In other features, the one or more pre-ceramic polymer layers of the one or more electrically conductive components maintain electrical insulation of the one or more electrically conductive components up to at least melting points of the one or more electrically conductive components.

In other features, the one or more electrically conductive components include at least one of a battery cell, a flex circuit, a busbar, a connector, a current collector, a structural enclosure, a heat exchanger, and a cooling plate.

In other features, the method further includes coating the one or more electrically conductive components such that the one or more pre-ceramic polymer layers are thicker at edges of the one or more electrically conductive components than at other areas of the one or more electrically conductive components.

In other features, the method further includes potting at least portions of the one or more electrically conductive components such that at least portions of the one or more electrically conductive components including corresponding portions of the one or more pre-ceramic polymer layers are disposed in potting material.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example apparatus including a rechargeable energy storage system (RESS) including pre-ceramic polymer coated electrically conductive components in accordance with the present disclosure;

FIG. 2 is a cross-section view of an example portion of a battery pack including pre-ceramic polymer coated electrically conductive components in accordance with the present disclosure;

FIG. 3 is a block diagrammatic view of an electrically conductive component including one or more pre-ceramic polymer coating layers in accordance with the present disclosure;

FIG. 4 is a perspective view of pre-ceramic polymer coated cylindrically shaped cells and heat exchangers of a battery pack in accordance with the present disclosure;

FIG. 5 is a top view of a battery pack include pre-ceramic polymer coated cylindrically shaped cells, current collectors and heat exchangers in accordance with the present disclosure;

FIG. 6 is a side perspective view of two pre-ceramic polymer coated cylindrically shaped cells in accordance with the present disclosure;

FIG. 7 is a side perspective view of two pre-ceramic polymer coated cylindrically shaped cells including coated connecting elements in accordance with the present disclosure;

FIG. 8 is a side perspective view of a stack of horizontally arranged pre- ceramic polymer coated cylindrically shaped cells in accordance with the present disclosure;

FIG. 9 is a perspective view of a portion of a pre-ceramic coated heat exchanger in accordance with the present disclosure;

FIG. 10 is a perspective view of pre-ceramic polymer coated prismatic cells in accordance with the present disclosure;

FIG. 11 is a top perspective view of a portion of a battery pack including pre-ceramic polymer coated electrically conductive components in accordance with the present disclosure;

FIG. 12 is a top perspective view of a portion of a pre-ceramic polymer coated cooling plate in accordance with the present disclosure;

FIGS. 13A and 13B (collectively FIG. 13) illustrates an example pre-ceramic polymer coating method in accordance with the present disclosure;

FIG. 14 is a functional block diagram of an example vehicle including a vehicle system including a RESS with pre-ceramic coated electrically conductive components in accordance with the present disclosure; and

FIG. 15 is a functional block diagram of an example manufacturing system in accordance with the present disclosure.

In the drawings, reference numbers may be reused to identify similar and/or identical elements.

### DETAILED DESCRIPTION

Electric and hybrid vehicles can include rechargeable energy storage systems (RESSs) with large battery packs, which may include battery pack modules and/or battery cells. The cells of each of the battery pack modules may be connected in series and/or parallel. The battery pack modules may also be connected in series or in parallel to provide various output voltages, such as 12V and 48V to power 12V loads and 48V loads. The battery pack modules may also be connected in series or in parallel for higher voltages such as 400V, 800V and voltages above 800V. The cells of a battery pack module may be implemented, for example, as cylindrically shaped cells, prismatic cells or pouch cells. The cells may be stacked vertically and/or arranged in various horizontal arrangements.

The battery packs can include various electrically conductive components such as the battery cells, structural enclosures, connectors, current collectors, flex circuits, heat exchangers, cooling plates, bus bars, and other electrically conductive components. Portions of some of these components are often coated with a polymeric coating such as epoxy or other oven or ultraviolet cured materials for the purposes of electrical isolation. These materials begin to degrade and/or soften at temperatures as low as 150-250° C. and are unable to withstand skin (or surface) temperatures of battery cells experienced, for example, during a thermal runaway event. Temperatures during a thermal runaway event can exceed 600-1000° C. During thermal runaway events, battery cell skin temperatures can well exceed working temperatures of the stated materials (i.e., temperatures at which the stated materials begin to degrade in performance) such as that of epoxy-based dielectric coatings. These coatings, even the ones rated to V-0 (UL-94) flammability levels, begin to thin, crack, bubble, and/or otherwise lose structural integrity and/or adhesion characteristics. This can cause loss of adhesion of the polymeric coating to the substrate which the polymeric coating is applied. When this happens, electrical isolation between, for example, battery cells and cooling heat exchangers located between the battery cells is lost and the heat exchangers can become electrical conductors.

Dielectric coating materials used on battery electric vehicles (BEVs) can degrade at temperatures greater than or equal to 200° C. When exceeding this temperature, thermal runaway propagation (TRP) can occur associated with a thermal runaway event. Whether TRP will occur is based on local coating thicknesses, coolant temperatures, battery cell temperatures, and other factors. Aluminum alloy, which is electrically conductive, has a melting point of 600-650° C. To prevent electrical shorts and/or arcs between battery cells, components can be coated with a dielectric material. In instances, where the battery cells themselves cannot provide all of the electrical isolation performance necessary for battery cell integration, cooling devices such as heat exchangers cooling plates, and/or other multi-port extruded components are often treated with dielectric materials and are positioned in contact with the battery cells to transfer thermal energy from the battery cells to a coolant.

The examples set forth herein include RESSs and battery packs including electrically conductive components that are coated with pre-ceramic material. This provides electrical isolation of the components within the RESSs during thermal runaway events. The pre-ceramic polymer coatings are high-temperature resistant dielectric coatings that maintain dielectric properties when thermal runaway happens and during a TRP. The coatings: prevent electrical arcing and shorts including during thermal runaway events; prevent corrosion of electrically conductive components; allow for increased RESS energy density by allowing for closer packaging of battery cells due to the ability to have thinner coatings; allow for a reduced amount of potting, elimination of potting material, and/or thinner potting layers; and can allow for the elimination of any other electrical isolation layers needed around busbars and flex circuits of the RESSs.

The examples disclosed herein are applicable to vehicle and non-vehicle implementations. The examples are applicable to internal combustion engine (ICE) vehicles, fully electric vehicles, battery electric vehicles (BEVs), hybrid electric vehicles including plug-in hybrid electric vehicles (PHEVs), partially or fully autonomous vehicles, and other types of vehicles. The examples are also applicable to, for example, electric bikes, network devices, portable electronic devices (e.g., mobile phones, wearable devices, laptop computers, etc.), computers, stationary and mobile power storage devices, and various other devices having battery pack modules.

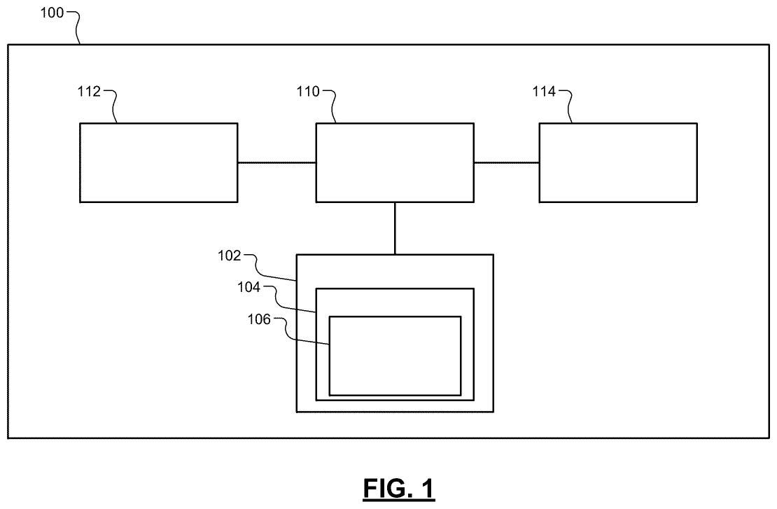

FIG. 1 is a functional block diagram of an example apparatus 100 including a rechargeable energy storage system (RESS) 102 including one or more battery packs 104 with electrically conductive components 106 that are pre-ceramic polymer coated. The apparatus 100 may be a vehicle, a network device, a portable electronic device, a bike, or other apparatus. The apparatus 100 may include the RESS 102, a control module 110, a memory 112, and one or more loads 114. The RESS 102 may include the battery packs 104 and may include other circuit components such as a control module, sensors, coolant pump, etc. As an example, the sensors may be used to monitor temperatures of the electrically conductive components 106. The control module of the RESS 102 or the control module 110 may adjust coolant flow to the battery packs based on the temperatures. The electrically conductive components 106 may include battery cells, heat exchangers, cooling plates, connectors, collectors, flex circuits, busbars, a structural enclosure, etc.

The control module 110 may supply power from the RESS 102 to the loads 114, as shown and/or may control transfer of power directly from the RESS 102 to the loads 114. Various examples of battery cells as referred to and described herein and others are applicable to the embodiment of FIG. 1. The loads 114 may include any electronic device drawing electrical current, such as lights, displays, electronic and/or electrical circuits, motors, compressors, pumps, actuators, etc. The loads 114 may be low-voltage and/or high-voltage loads.

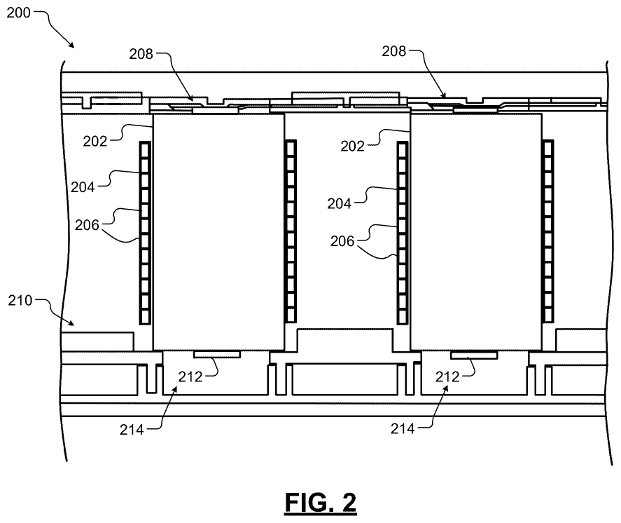

FIG. 2 shows a portion 200 of a battery pack including pre-ceramic polymer coated electrically conductive components. The battery pack includes cylindrically shaped battery cells 202, heat exchangers 204 with internal cooling channels 206, busbars 208, a cell tray 210, vents 212, TRP channels 214, etc. Each of the battery cells 202, the heat exchangers 204, the busbars 208, and other electrically conductive components of the battery pack are coated with pre-ceramic polymers, as described herein. By being coated as described herein, the heat exchangers 204 have reduced risk of losing electrical isolation when TRP occurs.

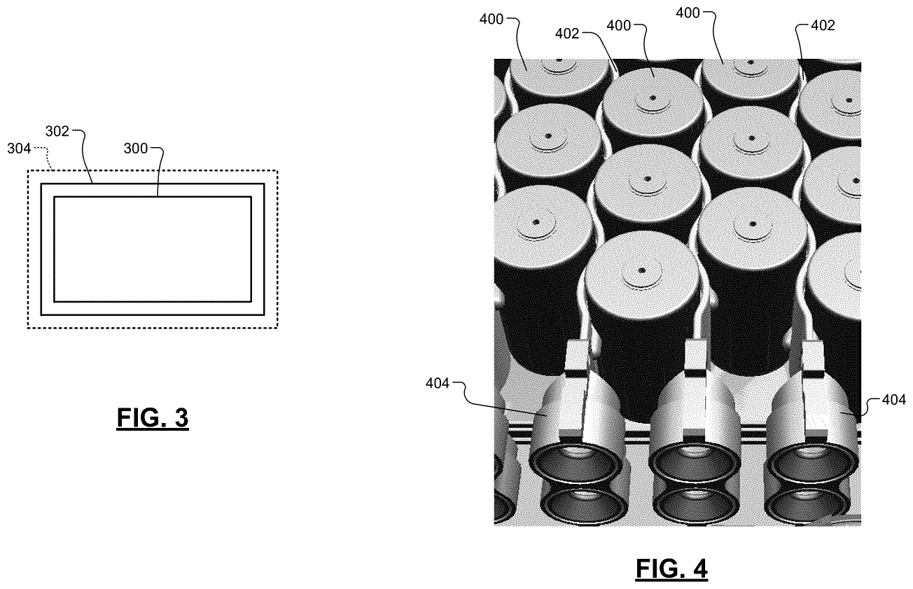

FIG. 3 shows an electrically conductive component 300 including one or more pre-ceramic polymer coating layers. The component 300 may be a battery cell, heat exchanger, cooling plate, connector, collector, flex circuit, busbar, a structural enclosure, etc. The battery cell may have a cylindrical, prismatic, pouch, and/or other form factor.

The pre-ceramic coating layers include a first pre-ceramic polymer layer 302 and may include one or more other pre-ceramic polymer layers 304. Each of the pre-ceramic polymer layers 302, 304 may include at least one of polysilazane (organics polysilazane (OPSZ)), polycarboslilane, polymeric aluminum phosphate, ceramics including boron nitride, nanotubes, titanium nitride, chromium carbide, magnesium zirconate, zirconia, titanium, and tungsten. In an embodiment, at least one of the layers 302, 304 is formed of OPSZ and is able to maintain thermal stability at 1000° C. with negligible or no mass loss. Each of the pre-ceramic polymer layers 302, 304 may include ceramic., which may be in a melted state during coating of the pre-ceramic polymer layer.

The coating thickness of each of the pre-ceramic polymer layers 302, 304 may be dependent upon dielectric performance of the coating material and system requirements. Based on a voltage per meter (V/m) dielectric constant, the thicknesses of each of the pre-ceramic polymer layers 302, 304 and/or other the pre-ceramic polymer layers may be selected such that a maximum overall thickness of the pre-ceramic polymer layers 302, 304 is between 1-500 microns (μm) thick. Each of the pre-ceramic polymer layers 302, 304 may be as thin as 1 μ. If there is only one pre-ceramic polymer layer, the thickness of that layer may be 1-500 μ. Each of the pre-ceramic polymer layers 302, 304 may have uniform thickness across each of the layers, or variable thickness such that the thickness changes across the layer. In an embodiment, one or more of the pre-ceramic polymer layers 302, 304 is thicker at the edges of the corresponding component being coated than in the bulk and/or other areas of the component.

The thickness election and/or variation may be done to satisfy, for example, a 3-80 kilovolt (kV) per millimeter (mm) dielectric strength isolation requirement. The applied pre-ceramic polymer materials of each of the pre-ceramic polymer layers 302, 304 may partially or completely coat the corresponding components including edges of the components. The components may be coated prior to, during, and/or subsequent to assembly of a corresponding battery pack and/or a RESS. Each of the pre-ceramic polymer layers 302, 304 may have an Underwriters Laboratories (UL) rating of V0 or V1.

FIG. 4 shows pre-ceramic polymer coated cylindrically shaped cells 400 and heat exchangers 402 of a battery pack. The heat exchangers 402 include inputs and/or output connectors 404. The cells 400, heat exchangers 402 and the connectors 404 are each coated with one or more layers of pre-ceramic polymer material as disclosed herein.

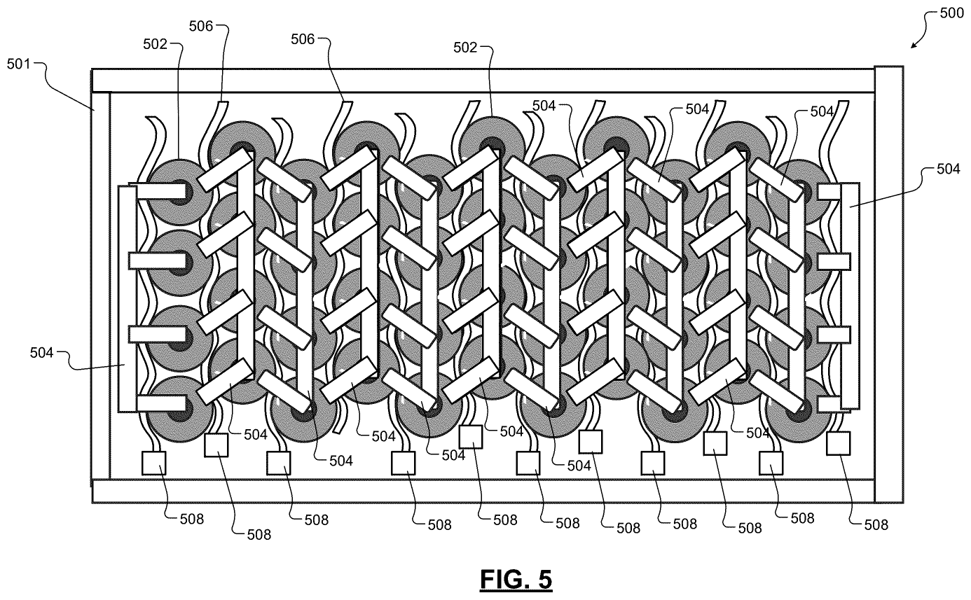

FIG. 5 shows a battery pack 500 that includes a structural enclosure 501, pre-ceramic polymer coated cylindrically shaped cells 502, current collectors 504 and heat exchangers 506. The heat exchangers 506 include respective connects 508. The heat exchangers 506 may be replaced with cooling plates. The heat exchangers 506 or cooling plates may extend between adjacent rows or between adjacent columns of the cells 502. The metal components of the battery pack 500 may be coated with pre-ceramic polymer material prior to assembly of the battery pack 500 and then the assembled battery pack 500 may be coated with pre-ceramic polymer material to cover any remaining exposed metal.

FIG. 6 shows two pre-ceramic polymer coated cylindrically shaped cells 600, 602. Each of the cells 600, 602 has a pre-ceramic polymer coating layer 604, 606. Each of the layers 604, 606 may include one or more pre-ceramic polymer layers. The pre-ceramic polymer coated cylindrically shaped cells 600, 602 may abut each other such that there is no gap between them. The distance between the cells 600, 602 is equal to a sum of a thickness of the pre-ceramic polymer coating layer 604 and a thickness of the pre-ceramic polymer coating layer 606. Although two cells are shown, any number of cells may be included and arranged such that they abut each other. The ability to abut the cells 600, 602 minimizes the amount of space needed for the cells 600, 602. Although no gap is shown between the cells 700, 702, there may be a gap between the cells 700, 702. A single cell may abut more than one cell. The cells 600, 602 may be potted. In the example shown, ends of the cells 700, 702 are potted in a polymer material such as epoxy. Any portion of the cells 700, 702 may be potted.

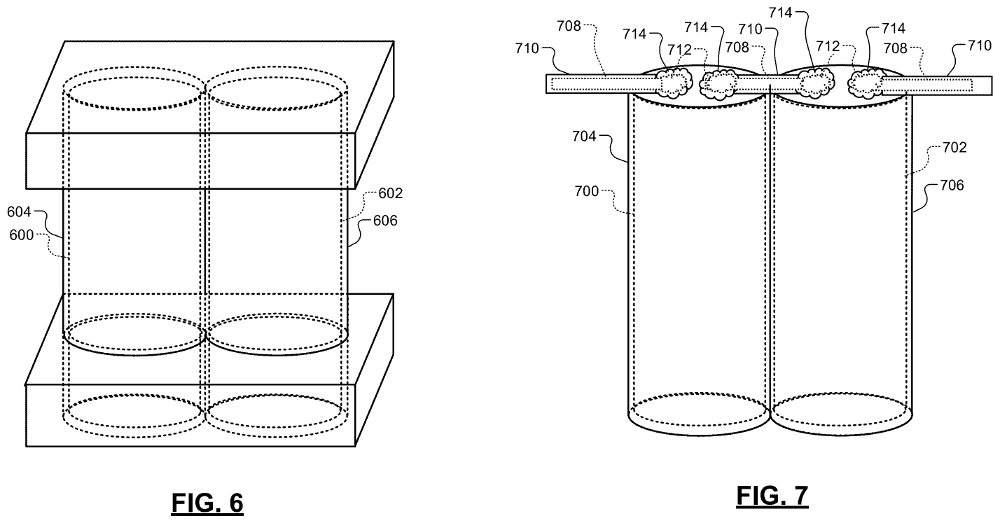

FIG. 7 shows two pre-ceramic polymer coated cylindrically shaped cells 700, 702 including coated connecting elements. The cells 700, 702 have pre-ceramic polymer coating layers 704, 706. Each of the layers 704, 706 may include one or more pre-ceramic polymer layers. Connectors 708 are shown, which connect the cell 700 to the cell 702 and another cell (not shown) and connect the cell 702 to another cell (not shown). The connectors 708 include pre-ceramic polymer coating layers 710. Ends 712, which connect to positive and negative terminals of the cells 700, 702, of the connectors 708 may also have pre-ceramic polymer coating layers 714. Although two cells are shown, any number of cells may be included.

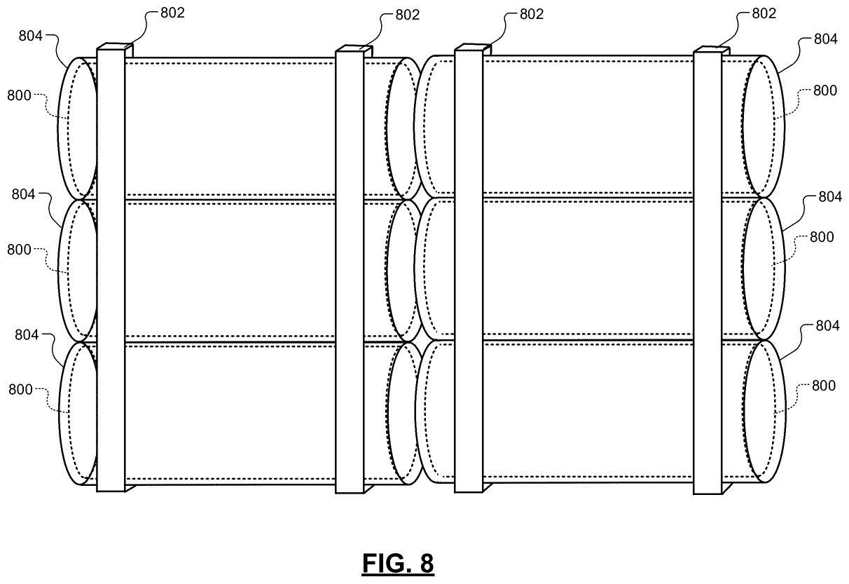

FIG. 8 shows a stack of horizontally arranged pre-ceramic polymer coated cylindrically shaped cells 800. The cells 800 are shown as being arranged in two vertical stacks. Any number of cells may be included and may be arranged in any number of vertical stacks. Each stack may include any number of cells. Each stack of cells may be held in place via retainers 802. The retainers 802 may be formed of plastic. The cells 800 have pre-ceramic polymer coatings 804. Each of the pre-ceramic polymer coating 804 may include one or more pre-ceramic polymer layers, as disclosed herein. The cells 800 may be connected in series and/or in parallel.

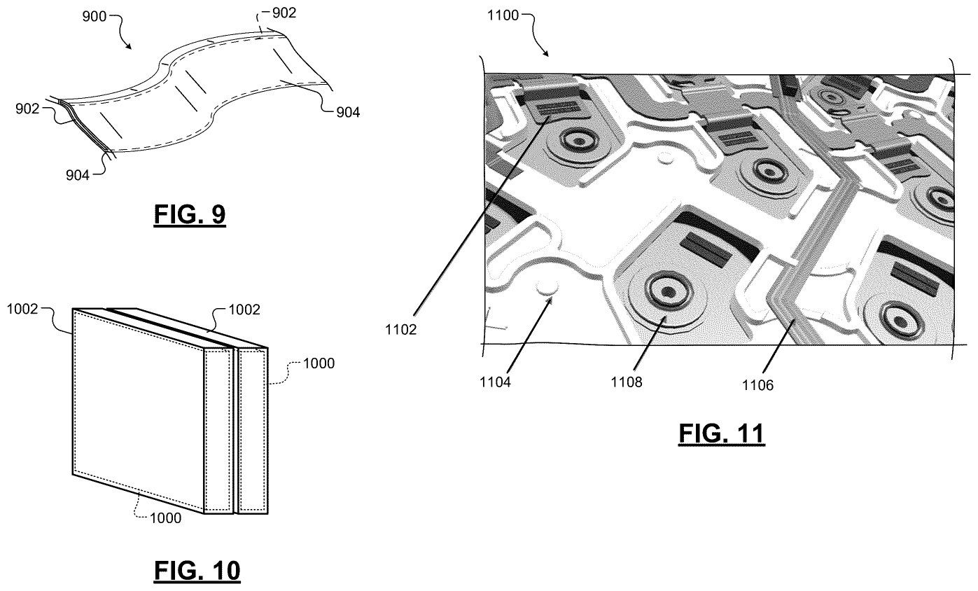

FIG. 9 shows a portion 900 of a pre-ceramic coated heat exchanger. The portion 900 includes an extruded rectangular tube 902 that is formed of metal and has one or more inner channels. The rectangular tube 902 is coated with one or more layers 904 of pre-ceramic polymer material. FIG. 10 shows pre-ceramic polymer coated prismatic cells 1000 that include one or more layers 1002 of pre-ceramic polymer material.

FIG. 11 shows a portion 1100 of a battery pack including pre-ceramic polymer coated electrically conductive components. The portion 1100 shows busbars 1102, an integrated circuit board frame 1104, a flex circuit 1106, and tops of cylindrically shaped cells 1108. The busbars 1102, flex circuit 1106, cells 1108 and/or other electrically conductive components (e.g., heat exchangers, cooling plates, and upper and lower shear plates) of the battery pack may each be coated with one or pre-ceramic polymer layers. The integrated circuit board frame 1104 may be formed of plastic.

The coatings of the electrically conductive components are highly temperature resistant and have low-dielectric constants. The coatings may include any of the pre-ceramic polymer materials referred to herein including electrically insulating pre-ceramic polymers such as polysilazane, polycarboslilane and/or ceramics including hexagonal boron nitride and boron nitride nanotubes. The ceramics maintain electric isolation until the metal coated by the ceramics melts. The coatings may be applied using methods such as dipping, spraying, electrostatic spraying, brushing, electrostatic powder coating, dipping in fluidized bed, electrophoretic deposition, and/or melt deposition. Some of the methods, such as electrostatic spraying and dipping in a fluidized bed include charging the component being coated and coating the component. The coating material is atomized and attracted to the charged component.

FIG. 12 shows a portion 1200 of a pre-ceramic polymer coated cooling plate 1202. The cooling plate 1202 includes one or more pre-ceramic polymer layers 1204 that encapsulate the cooling plate 1202. The cooling plate 1202 may have outward protruding portions 1206 having recessed areas 1208. The outward protruding portions 1206 having recessed areas 1208 are coated with the one or more pre-ceramic polymer layers 1204.

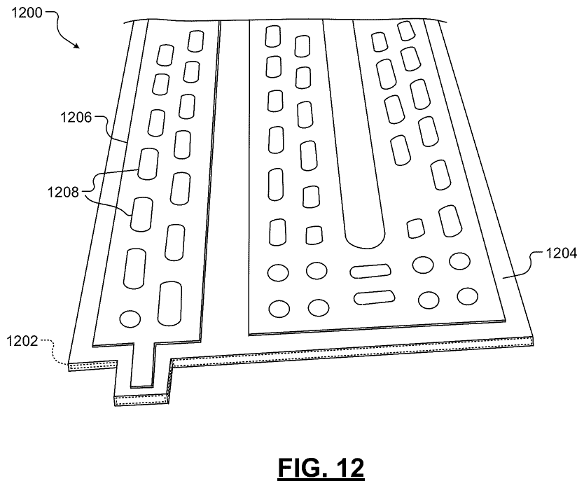

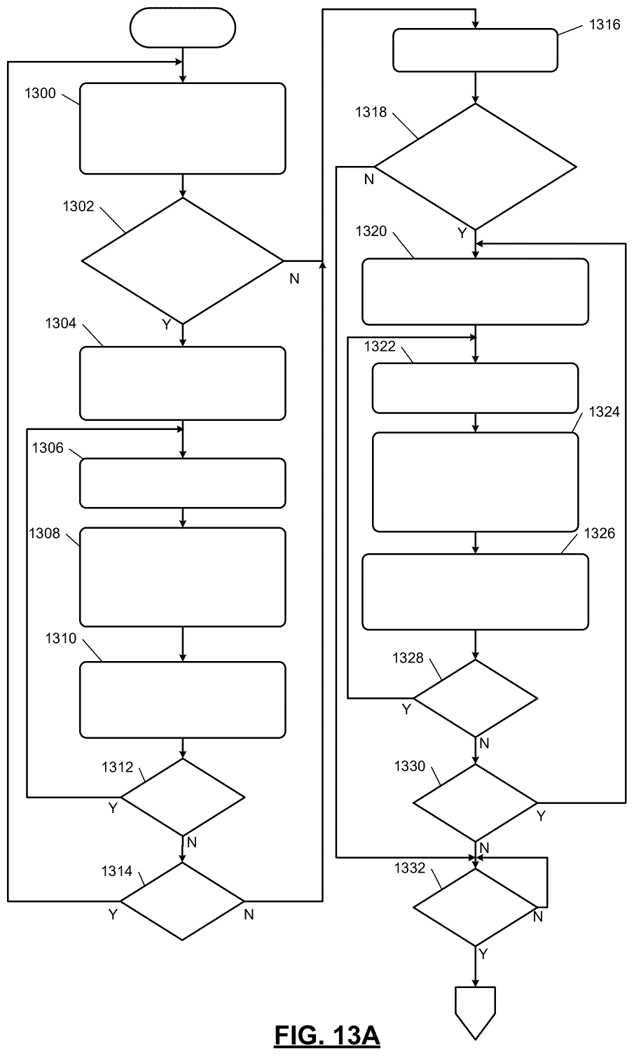

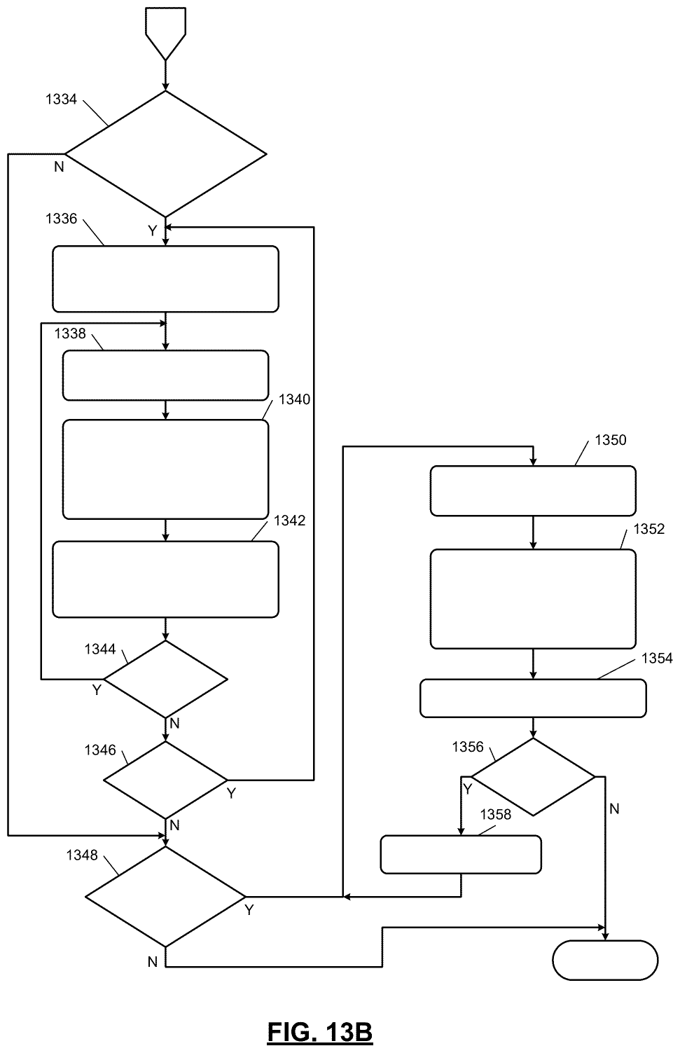

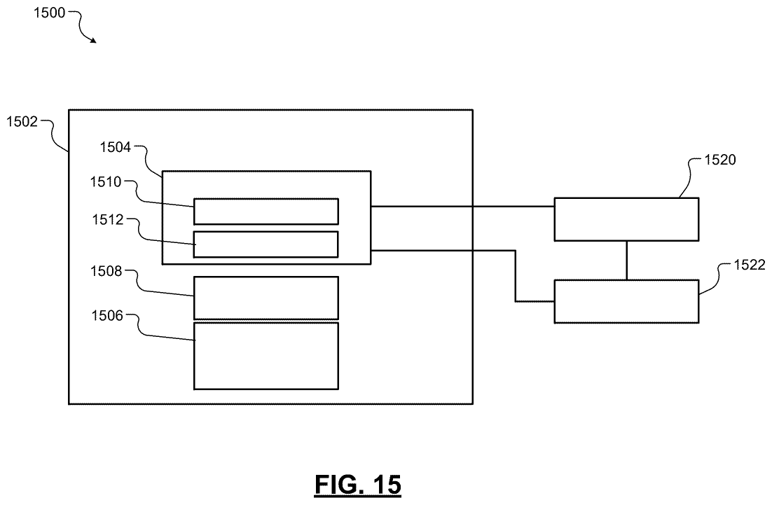

FIGS. 13A and 13B (collectively FIG. 13) shows a pre-ceramic polymer coating method. The operations of this method may be iteratively performed. The operations may be implemented by a control module (or controller) of a manufacturing system. The manufacturing system may further include: a chamber in which the components are coated; one or more robots for moving and manipulating each of the components being coated; a power source; grippers; electrically conductive grippers, clamps, connectors and/or electrodes; and/or one or more applicators, baths, beds, etc. for performing any of the above-stated dipping, spraying, electrostatic spraying, brushing, electrostatic powder coating, dipping in a fluidized bed, electrophoretic deposition or melt deposition methods. An example system is shown in FIG. 15. The method may be used to coat each electrically conductive component (or element) of a RESS such that each of the electrically conductive components remain electrically insulating up to their respective melting points.

At 1300, one or more electrically conductive components are selected for RESS to be coated with one or more pre-ceramic polymer layers. At 1302, the control module determined whether the one or more components are to be coated prior to assembly. If yes, operation 1304 may be performed, otherwise operation 1316 may be performed.

At 1304, surfaces of the one or more electrically conductive components are pretreated. The pretreatment may include cleaning the surfaces and/or chemically and/or mechanically modifying the surfaces for better acceptance of the pre-ceramic polymer to be applied during operation 1308. The pretreatment may include laser cleaning or laser texturing and improves adhesion of the following coatings applied at 1308. The pretreatment may include etching, which removes impurities and modifies and activates surfaces to bond to the following coating applied at 1308. The etching may include plasma etching, laser etching, chemical modification/etching, and current blasting (mechanical modification).

At 1306, a pre-ceramic polymer recipe is selected for coating the one or more electrically conductive components with selected pre-ceramic polymer material(s). In an embodiment, this recipe is selected prior to operation 1304 and includes a recipe for the pretreatment performed at 1304.

At 1308, the one or more electrically conductive components are coated according to the selected recipe using any of the above-stated pre-ceramic polymer materials. This may include any of the above-mentioned coating methods. The pre-ceramic polymer materials may include a silicone resin. The pre-ceramic polymer materials may include one or more pre-ceramic polymers such as polysilazane, polycarboslilane, polymeric aluminum phosphate, ceramics including boron nitride nanotubes, titanium nitride, chromium carbide, magnesium zirconate, zirconia, titanium, tungsten and/or combinations thereof.

At 1310, the pre-ceramic polymer coating is cured. This may include letting the coating dry at ambient temperature, baking the one or more electrically conductive components, curing the coating using ultraviolet light, etc. The curing may occur under an oxygen free atmosphere or under an oxygen containing atmosphere. At 1312, the control module determines whether another pre-ceramic polymer coating is to be applied to one or more of the same electrically conductive components. If yes, operation 1306 may be performed, otherwise operation 1314 may be performed.

At 1314, the control module determined whether there are more components to coat. If yes, operation 1300 may be performed, otherwise operation 1316 may be performed. At 1316, assembly of the corresponding RESS is started.

At 1318, the control module determines whether there are another one or more electrically conductive components to be coated during assembly of the RESS. If yes, operation 1320 is performed, otherwise operation 1332 is performed.

At 1320, surfaces of the another one or more electrically conductive components are pretreated. The pretreatment may include cleaning the surfaces and/or chemically and/or mechanically modifying the surfaces for better acceptance of the pre-ceramic polymer to be applied during operation 1324. The pretreatment may include laser cleaning or laser texturing.

At 1322, a pre-ceramic polymer recipe is selected for coating the another one or more electrically conductive components with selected pre-ceramic polymer material(s). In an embodiment, this recipe is selected prior to operation 1322 and includes a recipe for the pretreatment performed at 1322.

At 1324, the another one or more electrically conductive components are coated according to the selected recipe using any of the above-stated pre-ceramic polymer materials. This may include any of the above-mentioned coating methods. The pre-ceramic polymer materials may include a silicone resin. The pre-ceramic polymer materials may include one or more pre-ceramic polymers such as polysilazane, polycarboslilane, polymeric aluminum phosphate, ceramics including boron nitride nanotubes, titanium nitride, chromium carbide, magnesium zirconate, zirconia, titanium, tungsten and/or combinations thereof.

At 1326, the pre-ceramic polymer coating is cured. This may include letting the coating dry at ambient temperature, baking the one or more electrically conductive components, curing the coating using ultraviolet light, etc. The curing may occur under an oxygen free atmosphere or under an oxygen containing atmosphere. At 1328, the control module determines whether another pre-ceramic polymer coating is to be applied to one or more of the same electrically conductive components. If yes, operation 1322 may be performed, otherwise operation 1330 may be performed.

At 1330, the control module determined whether there are more components to coat. If yes, the components may be identified and operation 1318 may be performed, otherwise operation 1332 may be performed.

At 1332, the control module determines whether the assembly is completed. If yes, operation 1334 may be performed. At 1334, the control module determines whether there are another one or more electrically conductive components to be coated during assembly of the RESS. If yes, operation 1336 is performed, otherwise operation 1348 is performed.

At 1336, surfaces of the another one or more electrically conductive components are pretreated. The pretreatment may include cleaning the surfaces and/or chemically and/or mechanically modifying the surfaces for better acceptance of the pre-ceramic polymer to be applied during operation 1340. The pretreatment may include laser cleaning or laser texturing.

At 1338, a pre-ceramic polymer recipe is selected for coating the another one or more electrically conductive components with selected pre-ceramic polymer material(s). In an embodiment, this recipe is selected prior to operation 1336 and includes a recipe for the pretreatment performed at 1336.

At 1340, the another one or more electrically conductive components are coated according to the selected recipe using any of the above-stated pre-ceramic polymer materials. This may include any of the above-mentioned coating methods. The pre-ceramic polymer materials may include a silicone resin. The pre-ceramic polymer materials may include one or more pre-ceramic polymers such as polysilazane, polycarboslilane, polymeric aluminum phosphate, ceramics including boron nitride nanotubes, titanium nitride, chromium carbide, magnesium zirconate, zirconia, titanium, tungsten and/or combinations thereof.

At 1342, the pre-ceramic polymer coating is cured. This may include letting the coating dry at ambient temperature, baking the one or more electrically conductive components, curing the coating using ultraviolet light, etc. The curing may occur under an oxygen free atmosphere or under an oxygen containing atmosphere. At 1344, the control module determines whether another pre-ceramic polymer coating is to be applied to one or more of the same electrically conductive components. If yes, operation 1322 may be performed, otherwise operation 1330 may be performed.

At 1346, the control module determined whether there are more components to coat. If yes, the components may be identified and operation 1336 may be performed, otherwise operation 1348 may be performed.

At 1348, the control module determines whether there are components to be potted. If yes, operation 1350 may be performed, otherwise the method may end.

At 1350, a potting recipe may be selected. At 1352, at least portions of the components to be potted are potted according to the selected potting recipe. This may include potting first portions or ends of the components. At 1354, the potting material is cured. This may include baking the potted components and potting material.

At 1356, the control module determines whether more potting is to be performed. If yes, operation 1358 may be performed, otherwise the method may end.

At 1358, the components already potted or other components are arranged for potting. If the same components that were potted in the previous potting cycle are to be potted, this may include rotating the components 180° to coat opposite ends of the components. Examples of components where opposite ends have been potted are shown in FIG. 6.

The above-described operations are meant to be illustrative examples. The operations may be performed sequentially, synchronously, simultaneously, continuously, during overlapping time periods or in a different order depending upon the application. Also, any of the operations may not be performed or skipped depending on the implementation and/or sequence of events.

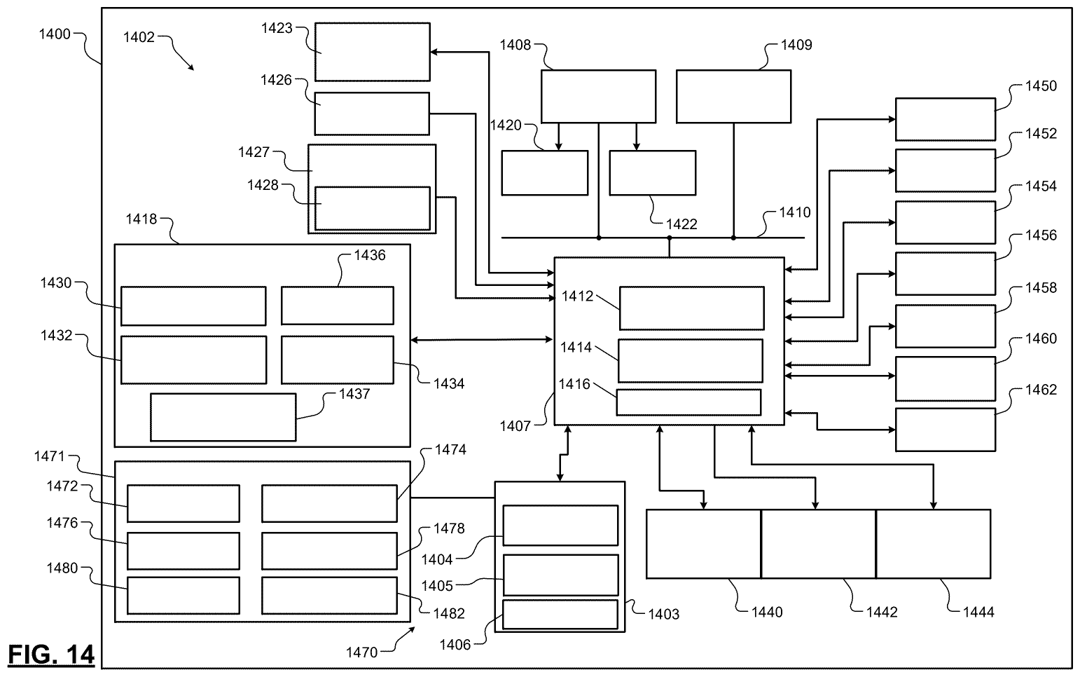

FIG. 14 shows a vehicle 1400 including a vehicle control system 1402 including a RESS 1403 with pre-ceramic coated electrically conductive components such as any of the electrically conductive components referred to herein. The RESS 1403 may include a control module 1404, battery packs 1405, and sensors 1406. The vehicle 1400 further includes a vehicle control module 1407, an infotainment module 1408 and other control modules 1409.

The modules 1404, 1407, 1408, 1409 may communicate with each other via one or more buses 1410, such as a controller area network (CAN) bus and/or other suitable interfaces. The vehicle control module 1407 may control operation of vehicles systems. The vehicle control module 1407 may include a mode selection module 1412, a parameter adjustment module 1414, as well as other modules 1416 (e.g., an active safety management module). The mode selection module 1412 may select a vehicle operating mode, such as one of the vehicle operating modes stated above. The parameter adjustment module 1414 may be used to adjust parameters of the vehicle 1400.

The vehicle 1400 may further include: a memory 1418; a display 1420; an audio system 1422; one or more transceivers 1423 including sensors 1426; and a navigation system 1427 including a global positioning system (GPS) receiver 1428. The sensors 1426 may include sensors, cameras, objection detection sensors, temperature sensors, accelerometers, vehicle velocity sensor, and/or other sensors. The GPS receiver 1428 may provide vehicle velocity and/or direction (or heading) of the vehicle and/or global clock timing information.

The memory 1418 may store sensor data 1430 and/or vehicle parameters 1432, RESS parameters 1434, and applications 1436. The applications 1436 may include applications executed by the modules 1404, 1407, 1408, 1409. As an example, the memory 1418 may store a thermal runaway application 1437, which may be implemented to predict, prevent and/or stop thermal runaway events (TREs). The thermal runaway application 1437 may be implemented by, for example, an active safety management module or other module referred to herein. Although the memory 1418 and the vehicle control module 1407 are shown as separate devices, the memory 1418 and the vehicle control module 1407 may be implemented as a single device.

The vehicle control module 1407 may control operation of an engine 1440, a converter/generator 1442, a transmission 1444, a window/door system 1450, a lighting system 1452, a seating system 1454, a mirror system 1456, a brake system 1458, electric motors 1460 and/or a steering system 1462 according to parameters set by the modules 1404, 1407, 1408, 1409. The vehicle control module 1407 may set some of the parameters based on signals received from the sensors 1426. The vehicle control module 1407 may receive power from the RESS 1403, which may be provided to the engine 1440, the converter/generator 1442, the transmission 1444, the window/door system 1450, the lighting system 1452, the seating system 1454, the mirror system 1456, the brake system 1458, the electric motors 1460 and/or the steering system 1462, etc. Some of the vehicle control operations may include unlocking doors of the window/door system 1450, enabling fuel and spark of the engine 1440, starting the electric motors 1460, powering any of the systems 1450, 1452, 1454, 1456, 1458, 1462, and/or performing other operations as are further described herein.

The engine 1440, the converter/generator 1442, the transmission 1444, the window/door system 1450, the lighting system 1452, the seating system 1454, the mirror system 1456, the brake system 1458, the electric motors 1460 and/or the steering system 1462 may include actuators controlled by the vehicle control module 1407 to, for example, adjust fuel, spark, air flow, steering wheel angle, throttle position, pedal position, door locks, window position, seat angles, etc. This control may be based on the outputs of the sensors 1426, the navigation system 1427, the GPS receiver 1428 and the above-stated data and information stored in the memory 1418.

The vehicle control module 1407 may determine various parameters including a vehicle speed, an engine speed, an engine torque, a gear state, an accelerometer position, a brake pedal position, an amount of regenerative (charge) power, an amount of boost (discharge) power, an amount of auto start/stop discharge power, and/or other information, such as priority levels of source terminals of the RESS 1403, power, current and voltage demands for each source terminal, etc. The vehicle control module 1407 may share this information and the vehicle operating mode with the control module 1404. The control module 1404 may determine other parameters, such as: an amount of charge power at each source terminal; an amount of discharge power at each source terminal; maximum and minimum forces at cells, blocks, packs, and/or groups; maximum and minimum voltages at source terminals; maximum and minimum voltages at power rails, cells, blocks, and/or packs; state of charge values of cells, blocks, and/or packs; temperatures of cells, blocks, and/or packs; current values of cells, blocks, and/or packs; power values cells, blocks, and/or packs; etc. The control module 1404 may determine connected configurations of the cells and corresponding switch states based on the parameters determined by the vehicle control module 1407 and/or the control module 1404.

The vehicle 1400 includes an active safety management (ASM) system 1470, which includes the ASM module, the RESS 1403, and the control module 1404. The ASM module may be implemented as part of the control module 1404. The vehicle 1400 may further include a thermal management system (TMS) 1471 that is used to maintain the temperature of battery packs 1405 and also for discharging suspicious and/or faulty blocks of cells. The ASM module may control connection to and operation of the TMS 1471. The TMS 1471 may include a cooling fan 1472, a cooling pump 1474, a cell balancing system 1476, a thermal electric generator (e.g., a Peltier cooler) 1478, a resistive load 1480 and/or other TMS loads 1482. The cooling fan 1472 and the cooling pump 1474 may be used to circulate air and/or a coolant through the RESS 1403. Discharging suspicious and/or faulty cells by powering the cooling fan 1472 and/or the cooling pump 1474 serves multiple purposes. The powering of the cooling fan 1472 and/or the cooling pump 1474 cools cells of the RESS 1403 including the suspicious and/or faulty cells while the charge of the suspicious and/or faulty cells is reduced or suspended. This removes a potential hazard associated with the suspicious and/or faulty cells. The fan may also be reversed if the airflow provides cooler air in this direction. Any of the TMS loads 1472, 1474, 1476, 1478, 1480, 1482 may be connected to discharge the suspicious and/or faulty cells. The connection of the TMS loads may also reduce risk of a thermal chain reaction with cells adjacent the suspicious and/or faulty cells.

FIG. 15 shows a manufacturing system 1500 that may implement the method of FIG. 13 and/or other method for coating components as disclosed herein. The manufacturing system 1500 may include a chamber 1502. One or more robots 1504 and component supports 1506. The component supports 1506 may include tables, baths, beds, racks, hangers, etc. The component supports 1506 may support components 1508 be coated. In an embodiment, the components are supported by the robots 1504. The robots 1504 may include applicators 1510 and/or grippers 1512. A control module 1520 may control operation of the robots 1504. A power source 1522 may be connected to a supply power to the control module 1520 and the robots 1504.

The examples disclosed herein include energy storage systems, which may be rechargeable, including electrically conductive components with pre-ceramic polymer coatings. The pre-ceramic polymer coatings efficiently transfer thermal energy while providing electrical and thermal isolation. The coatings enable placement of components next to each other. The coats are able to be applied prior to, during and subsequent to assembly the energy storage systems. The coatings are able to be applied after components are welded. If applied before components are welded, then the welding process may expose metal surfaces that were previously coated.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java@, Fortran, Perl, Pascal, Curl, OCaml, Javascript@, HTML5 (Hypertext Markup Language 5th revision), Ada, ASP (Active Server Pages), PHP (PHP: Hypertext Preprocessor), Scala, Eiffel, Smalltalk, Erlang, Ruby, Flash@, Visual Basic®, Lua, MATLAB, SIMULINK, and Python®.

What is claimed is:

1. An energy storage system comprising:
at least one battery pack; and
one or more electrically conductive components each of which comprising one or more pre-ceramic polymer layers, wherein the one or more pre-ceramic polymer layers of each of the one or more electrically conductive components electrically insulate the one or more electrically conductive components from other electrically conductive components of the at least one battery pack.

2. The energy storage system of claim 1, wherein the at least one battery pack comprises the one or more electrically conductive components.

3. The energy storage system of claim 1, wherein the one or more pre-ceramic polymer layers of the one or more electrically conductive components maintain electrical insulation of the one or more electrically conductive components up to at least melting points of the one or more electrically conductive components.

4. The energy storage system of claim 1, wherein the one or more pre-ceramic polymer layers of the one or more electrically conductive components comprises at least one of polysilazane (organics polysilazane (OPSZ)), polycarboslilane, polymeric aluminum phosphate, ceramics including boron nitride, nanotubes, titanium nitride, chromium carbide, magnesium zirconate, zirconia, titanium, and tungsten.

5. The energy storage system of claim 1, wherein the one or more pre-ceramic polymer layers of the one or more electrically conductive components comprises a silicone resin.

6. The energy storage system of claim 1, wherein the one or more electrically conductive components comprise at least one of a battery cell, a flex circuit, a busbar, a connector, a current collector, a structural enclosure, a heat exchanger, and a cooling plate.

7. The energy storage system of claim 1, wherein the one or more electrically conductive components comprise a plurality of battery cells that are cylindrically shaped, prismatically shaped, or pouch shaped.

8. The energy storage system of claim 7, wherein the plurality of battery cells are stacked.

9. The energy storage system of claim 1, wherein the one or more electrically conductive components comprise connectors connecting a plurality of battery cells.

10. The energy storage system of claim 1, wherein the one or more electrically conductive components comprise a current connector connected to a plurality of battery cells.

11. The energy storage system of claim 1, wherein the one or more pre-ceramic polymer layers of the one or more electrically conductive components are thicker at edges of the one or more electrically conductive components than at other areas of the one or more electrically conductive components.

12. The energy storage system of claim 1, wherein the one or more pre-ceramic polymer layers of the one or more electrically conductive components have UL-94 ratings of V0 or V1.

13. The energy storage system of claim 1, wherein the one or more electrically conductive components are potted such that at least portions of the one or more electrically conductive components including corresponding portions of the one or more pre-ceramic polymer layers are disposed in potting material.

14. The energy storage system of claim 1, wherein the one or more electrically conductive components comprises a plurality of pre-ceramic polymer layers including the one or more pre-ceramic polymer layers.

15. A method of manufacturing an energy storage system, the method comprising:
selecting one or more electrically conductive components to coat;
pretreating surfaces of the one or more electrically conductive components;
coating the one or more electrically conductive components with a pre-ceramic polymer material to form one or more pre-ceramic polymer layers on surfaces of the one or more electrically conductive components; and
curing the one or more pre-ceramic polymer coating layers.

16. The method of claim 15, wherein the one or more pre-ceramic polymer layers of the one or more electrically conductive components comprises at least one of polysilazane (organics polysilazane (OPSZ)), polycarboslilane, polymeric aluminum phosphate, ceramics including boron nitride, nanotubes, titanium nitride, chromium carbide, magnesium zirconate, zirconia, titanium, and tungsten.

17. The method of claim 15, wherein the one or more pre-ceramic polymer layers of the one or more electrically conductive components maintain electrical insulation of the one or more electrically conductive components up to at least melting points of the one or more electrically conductive components.

18. The method of claim 15, wherein the one or more electrically conductive components comprise at least one of a battery cell, a flex circuit, a busbar, a connector, a current collector, a structural enclosure, a heat exchanger, and a cooling plate.

19. The method of claim 15, further comprising coating the one or more electrically conductive components such that the one or more pre-ceramic polymer layers are thicker at edges of the one or more electrically conductive components than at other areas of the one or more electrically conductive components.

20. The method of claim 15, further comprising potting at least portions of the one or more electrically conductive components such that at least portions of the one or more electrically conductive components including corresponding portions of the one or more pre-ceramic polymer layers are disposed in potting material.
